(19) United States
(12) Patent Application Publication
(10) Pub. No.: US 2016/0219079 A1
(43) Pub. Date: Jul. 28, 2016

(54) AUTONOMOUS CONTROL SYSTEMS AND METHODS FOR PROTECTING INFRASTRUCTURE

(71) Applicant: Temporal Defense Systems, LLC, Renton, WA (US)

(72) Inventors: Ronald Lance JUSTIN, Santa Barbara, CA (US); Charles ELDEN, Dunnellon, FL (US); Jared KARRO, Charlotte, NC (US); Mark TUCKER, Kirkland, WA (US)

(21) Appl. No.: 14/933,457

(22) Filed: Nov. 5, 2015

Related U.S. Application Data
(60) Provisional application No. 62/076,164, filed on Nov. 6, 2014.

(51) Int. Cl. H04L 29/06

(52) U.S. Cl. CPC H04L 63/20; H04L 63/06; H04L 63/123

(57) ABSTRACT

A system for autonomous enforcement of rules may comprise a protected system, including infrastructure, operative in response to input signals and an autonomous control system. The autonomous control system may include a monitor circuit which is coupled to the input signals to monitor the input signals for violations of the rules and an action circuit coupled to the protected system which prevents the violating input signals from affecting the protected system.

### CROSS-REFERENCE TO RELATED APPLICATIONS

This application claims the benefit of the filing date of U.S. Provisional Patent Application No. 62/076,164, filed Nov. 6, 2014, the entirety of which is incorporated by reference herein. This application also incorporates U.S. patent application Ser. No. 14/523,577, filed Oct. 24, 2014, by reference in its entirety.

### BRIEF DESCRIPTIONS OF THE DRAWINGS

FIG. 1 is a protected system, autonomous control system, and input device according to an embodiment of the invention.

FIG. 2 is a serially interfaced autonomous control system according to an embodiment of the invention.

FIG. 3 is a flow diagram depicting a control method according to an embodiment of the invention.

FIG. 4 is a serially interfaced autonomous control system according to an embodiment of the invention.

FIG. 5 is a schematic diagram depicting operation of a serially interfaced autonomous control system according to an embodiment of the invention.

FIG. 6 is a serially interfaced autonomous control system according to an embodiment of the invention.

FIG. 7 is a parallel interfaced autonomous control system according to an embodiment of the invention.

FIG. 8 is a parallel interfaced autonomous control system according to an embodiment of the invention.

FIG. 9 is a schematic diagram depicting operation of a parallel interfaced autonomous control system according to an embodiment of the invention.

FIG. 10 is a serially and parallel interfaced autonomous control system according to an embodiment of the invention.

FIG. 11 is an autonomous control system comprising a communication bus according to an embodiment of the invention.

FIG. 12 is an autonomous control system including a semiconductor multi-chip module according to an embodiment of the invention.

FIG. 13 is an autonomous control system mounted externally on an interposer PCB according to an embodiment of the invention.

FIG. 14 is a flow diagram depicting anti-tamper features of an autonomous control system according to an embodiment of the invention.

FIG. 15 shows a process flow of using an autonomous control system as a system service to a host CPU for secure co-processing according to an embodiment of the invention.

FIG. 16 is a serially interfaced autonomous control system with authenticate/disrupt/repair logic according to an embodiment of the invention.

FIG. 17 is a multi-interface autonomous control system according to an embodiment of the invention.

FIG. 18 is an endpoint including a memory mapped peripheral according to an embodiment of the invention.

### DETAILED DESCRIPTIONS OF SEVERAL EMBODIMENTS

Electronic, mechanical, chemical, and biological systems may have states or sequences of states that can lead to catastrophic failure. Such fatal states can occur from internal natural forces, external accidental forces, or external intentionally hostile forces. In industrial systems, actuating devices or systems under remote control and monitoring may have known detrimental states that could be allowed by the control system as a result of malfunction, user error, or a malicious or hostile act. The actuating device may accept and execute such commands or out of bounds signals, causing the overall related system to suffer, degrade, or destruct from such an induced state. For example, an induced detrimental system state may be a process speed that is too fast or too slow, a valve that is opened too far or closed too tight, or a pressure or temperature that is too high or too low. Many devices may lack their own internal safeguards to physically or electronically prevent these out of bounds operations.

The systems and methods described herein may provide autonomous control that may monitor and modify or block input and/or output signals in accordance with business and/or security rules in order to protect system critical components. Signal modification and/or blocking may ensure that out of bounds connection states between and within devices or systems either do not occur or only occur for inconsequential amounts of time to minimize or prevent undesired system effects. (A connection state may be any monitored signal level or command between two or more devices or systems at a particular instant of time at the physical layer level. The physical layer may be the lowest hardware layer of a device or a system where raw signals are transferred, for example.) When signals that violate the rules are detected, an autonomous control system (e.g., a circuit) may block the violating signals by internally switching them off. The circuit may instead send no signal or a failsafe signal to a protected system, which may be any device or system under protection by the autonomous control system. The circuit may be configured for use with legacy systems, for example by being designed into a system upgrade or retrofitted to the system.

Systems and methods described herein may comprise one or more computers, which may also be referred to as processors. A computer may be any programmable machine or machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used. Computers may be linked to one another via a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Wi-Fi, WiMax, or other wireless connections). Connections between computers may use any protocols, including connection-oriented protocols such as TCP or connectionless protocols such as UDP. Any connection through which at least two computers may exchange data can be the basis of a network.

Some embodiments described herein may protect critical infrastructure connected over the Internet or other network technologies to Industrial Control Systems (ICS) and/or Supervisory Control and Data Acquisition (SCADA) systems. For example, autonomous control systems may be placed at the lowest level of an ICS/SCADA system (e.g., the connection between the control system and an intelligent device that is the endpoint actuator of a physical process or embedded in the control system at the interface with the intelligent device). In Purdue Enterprise Reference Architecture (PERA) terms, this is the Level 0 and Level 1 interface and is the last possible line of defense against a malicious act or a user error or system malfunction on a physical process in some cases.

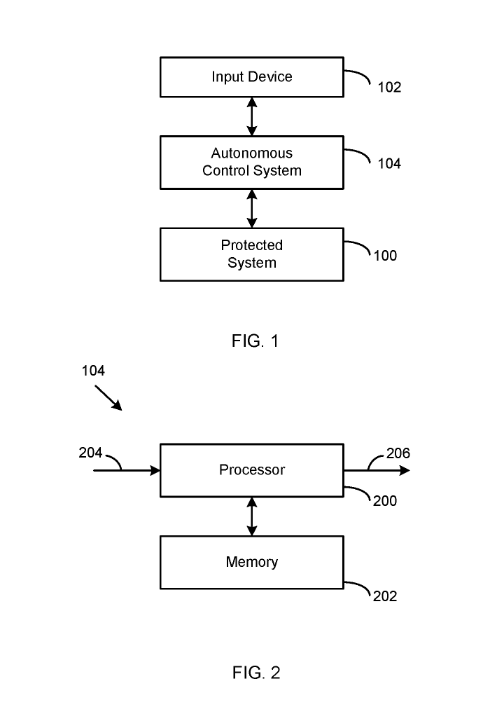

FIG. 1 illustrates a protected system 100. The protected system 100 may be in communication with an input device 102. The input device 102 may send signals to and/or receive signals from the protected system 100. The input device may be, for example, an analog or digital signal port, a control knob, a touch display, a keyboard, a mouse, and/or some other peripheral device. The input device 102 may also be a host device for the protected system 100 or a device on a network. In some embodiments, the protected system 100 may be an ICS/SCADA endpoint, and the input device 102 may be an ICS/SCADA system interface which may include a programmable logic device (PLD), field programmable gate array (FPGA), complex programmable logic device (CPLD), etc. An autonomous control system 104, which may be referred to as a dedicated monitoring and action device (DMAD), may be positioned serially between the input device 102 and the protected system 100 and/or in parallel with the input device 102 and the protected system 100. As described in greater detail below, various embodiments of the autonomous control system 104 may comprise electronic circuits, processors and memory configured to execute software, or a combination thereof. An autonomous control system 104 may be internally secure (e.g., including encryption and anti-tamper capabilities). Autonomous control system 104 may also be manifested serially or in parallel to the data connections between input device/host 102 and protected system 100 in both directions of data flow, so that the autonomous control system 104 may monitor input signals coming to protected system 100 and output signals coming from protected system 100.

In some embodiments, the autonomous control system 104 may create a deterministic race condition to enforce rules. A deterministic race condition may be an intentionally induced race condition between an injected signal and an oncoming signal such that there is a high level of certainty that only the injected signal will affect the output. As rule violating signals emerge on the data bus to or from a protected system 100, the autonomous control system 104 may race to detect the violation and may either internally switch off the signal and substitute failsafe signals if serially interfaced or may attempt to modify the signal if parallel interfaced. Incoming and/or outgoing signals may be buffered to provide more detection time and guarantee that only validated signals are transmitted by the autonomous control system 104 to the protected system 100 or vice versa.

In some embodiments, the autonomous control system 104 may be physically manifested in the protected system 100 or physically connected to the protected system 100 or a control device in a variety of ways such as silicon die on die, integrated circuit package on package, modularized system module on module, fiber-optic, radio-frequency, wire, printed circuit board traces, quantum entanglement, or molecular, thermal, atomic or chemical connection.

In some embodiments, the autonomous control system 104 may include physical interfaces that connect serially, in parallel, or both in serial and parallel between one or more devices or systems (e.g., the input device 102 and protected system 100). Each physical connection type may have a different set of design considerations and tradeoffs for a given application and system type such as organic, electronic, or radio frequency. For example, in an electronic system, voltage interface levels, signal integrity, drive strength, anti-tamper, and/or induced propagation delays may be evaluated to determine the connection method.

In some embodiments, the autonomous control system 104 may be a computer system with encrypted memory storage and anti-tamper features that may be designed, programmed, and positioned to autonomously enforce specific security and business rules on a host system or device. The autonomous control system 104 may include components such as processing logic, memory storage, input/output buffers, communication ports, and/or a reprogramming port. The autonomous control system 104 may constantly analyze connection states in real time between any number of devices or systems and may enforce predefined business and security rules. When out of bounds states are detected, the autonomous control system 104 may block, override, or change the prohibited connection state to a known good state. Similar methods may be applied to electrical, optical, electro-mechanical, electromagnetic, thermal, biological, chemical, molecular, gravitational, atomic, or quantum mechanical systems, for example.

In some embodiments, the autonomous control system 104 may include a programmable device that may be programmed to autonomously behave deterministically in response to stimuli. For example, the autonomous control system 104 may include a FPGA, a microcontroller (MCU), microprocessor (MPU), software-defined radio, electro-optical device, quantum computing device, organic compound, programmable matter, or a programmable biological virus. The autonomous control system 104 may be connected to the protected system 100 directly or to one or more control devices acting on the protected system 100. The autonomous control system 104 may be connected physically, such as by silicon die on die, integrated circuit package on package, modularized system module on module, fiber-optic, radio-frequency, wire, printed circuit board traces, quantum entanglement, molecular, thermal, atomic, or chemical means.

In some embodiments, the autonomous control system 104 may securely store data (such as cryptographic certificates or system logs) separate from the protected system 100 memory so that it may only be accessed or modified with stronger authentication methods and access controls than the protected system 100 provides. For example, the autonomous control system 104 may be used by a computer system to implement a security scoring methodology (e.g., the autonomous control system 104 may be used for storage of security certificates and requirement information). Furthermore, the security scoring method may leverage the autonomous control system 104 for validation/verification, authentication, and authorization of outside resources based on security score information. The stored data may be used for verification of security integrity in combination with other systems, for example.

In some embodiments, the autonomous control system 104 may be used to implement electronic cryptographic public-key infrastructure (PKI) inside of electronic systems to ensure integrity and authenticity of internal system components, data, and/or externally interfaced devices. In addition, these certificates may be leveraged for secure communications, ensuring the confidentiality, integrity, and/or authenticity of messages. For example, a autonomous control system 104 that implements and enforces electronic cryptographic PKI may include a read-only memory (ROM) partition that contains a public key or Globally Unique Identifier (GUID) that may be programmed during the system's initial fabrication. A private key may then be internally generated by the autonomous control system 104, for example using industry standard cryptographic methods such as RSA and X.509 certificates, at the first boot-up of the autonomous control system 104. This private key may then be used to generate a certificate request, which may be signed by the manufacturer's certificate authority (CA) or an approved third party CA. The signed certificate may then be securely stored on the ROM of the autonomous control system 104. This certificate may then be used to enable digital signing and encryption/decryption of data. An autonomous control system 104 that implements electronic cryptographic PKI may be retrofitted into a protected system 100 that does not implement electronic cryptographic PKI in order to add such a capability. This may have the benefit of having the private key being stored in a location inaccessible to the protected system 100 for added security.

In some embodiments, the autonomous control system 104 may be used with an electronic cryptographic PKI to validate that internal protected system 100 components are authentic, and other (internal protected system 100 and/or external input device 102) components may also be able to implement PKI so that public keys can be exchanged, stored, and authenticated. If a protected system 100 or input device 102 component that implements PKI was tampered with and replaced with a counterfeit version, then the autonomous control system 104 may be able to detect the counterfeit because the counterfeit device's signature may either be non-existent or different from that of the original.

In some embodiments, the autonomous control system 104 may utilize cryptographic methods (such as PKI) to ensure data integrity within a protected system 100 and other (e.g., external input device 102) system components. The autonomous control system may also implement cryptographic methods ensuring data has not been altered in any way. In addition, the authenticity of the data may be guaranteed, as the originator of the data may be proven or validated. For example, the autonomous control system 104 may use a peripheral's public key to encrypt messages intended for the peripheral and verify messages received from the peripheral.

In some embodiments, the autonomous control system 104 may implement electronic cryptographic PKI and may also ensure integrity and authenticity of virtual machines and or hypervisors (generally referred to as the “virtual system”) by generating cryptographically signed hashes of the virtual system (or its components) and storing those hashes. The autonomous control system 104 may then validate the authenticity and integrity of the virtual system by recalculating the hash and comparing it to the stored value. Furthermore, the autonomous control system 104 may emulate the protected system 100 full time, at pre-determined or randomized time periods, and/or for pre-determined or randomized durations, such that any commands received do not reach the protected system 100, thereby preventing effects on the protected system 100. This mode of operation may be used for testing or for giving an attacker the impression that an attack was successful when in reality the malicious intent was never actuated at the protected system 100. The autonomous control system 104 may include offensive measures which may neutralize a threat when prohibited connection states, commands, and/or sequences of commands are detected. For instance, if an unauthorized connection is detected on a USB port, then the autonomous control system 104 may inject signals into the USB peripheral input device 102 to damage or neutralize it.

In some embodiments, the autonomous control system 104 may be an electronic circuit design on an integrated circuit chip which may be connected serially to the physical interface of a second integrated circuit chip in a control device in such a way that it has a negligible effect on system performance and function. At the same time, the first integrated circuit chip may be able to prohibit certain connection states to the second integrated circuit chip. The connection state may be the signal level on every connection point between two devices at a given instant of time such as the voltage level on every digital I/O connection. Alternatively, an electronic device may be inserted at or added onto a signal interface that may include external constant monitoring of some or all of the signal levels or states between one or more electronic devices or systems and acts to ensure that out of bounds signal states between devices or systems either do not occur or only occur for inconsequential amounts of time such that undesired system effects will not occur. An electronic device that implements this method may connect serially, in parallel, or both in serial and parallel between one or more devices or systems and may function independently or with external monitoring and control including with a computer-implemented security scoring method.

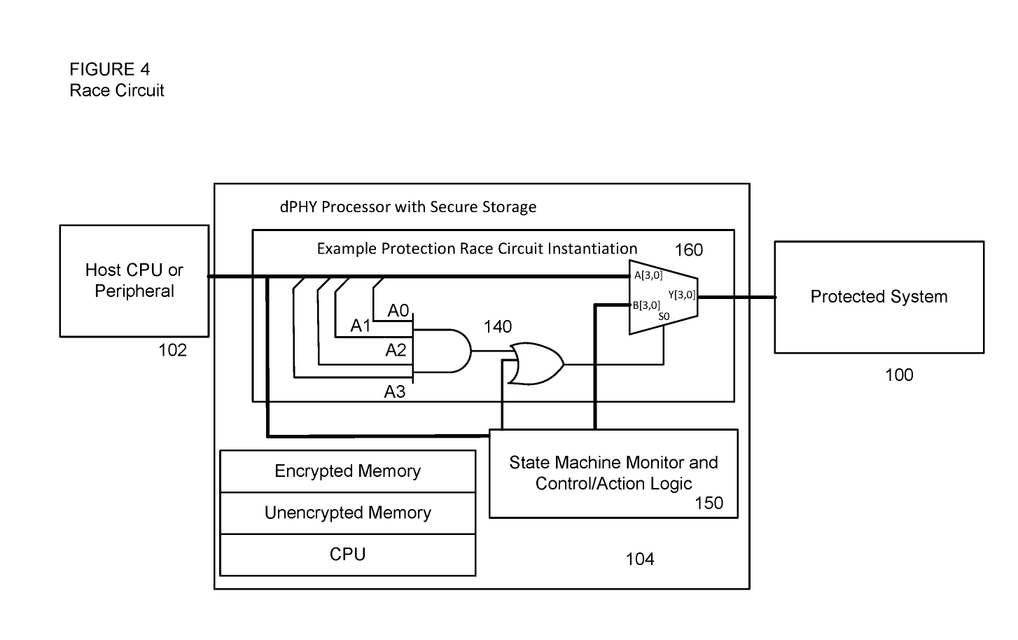

In some embodiments (e.g., as shown in FIG. 4 described below), the autonomous control system 104 may operate as a hardware-based serial “man-in-the-middle” (MITM). Communication between the protected system 100 and input device 102 (e.g., a peripheral) may continue normally until the monitoring logic of the autonomous control system 104 detects a pre-programmed prohibited signal pattern, packet, or access attempt on the signal lines. When the prohibited signal is detected, the autonomous control system 104 may completely disable the primary signal bus by selecting an alternate signal bus (or disrupt bus). The alternate signal bus may be used for recording, disrupting, or total disconnection from the peripheral. The alternate signal bus may be selected while communication is maintained with the protected system 100, for example to notify the protected system 100 that it is under attack. The autonomous control system 104 may maintain this communication by using an internal parameterized multiplexor instantiation whose channel select lines are controlled by the application-specific monitoring and action logic that is programmed into the protected system 100, for example.

FIG. 2 illustrates an embodiment of the autonomous control system 104 comprising a processor 200 and a memory 202 in a serial arrangement with an input device 102 (not shown) and a protected system 100 (not shown). The processor 200 may receive input signals on node 204, which may be connected to the input device 102. The processor may generate output signals on node 206, which may be routed to the protected system 100. The memory 202 may store prohibited input signal states. The processor 200 may compare input signals to the prohibited input signal states and may produce a match signal or a no match signal. The input signals may be supplied to the protected system 100 in response to the no match signal. Substitute input signals may be supplied to the protected system 100 in response to the match signal. The substitute input signals may be signals that cause no damage to the protected system 100. For example, an input to the protected system 100 directing a motor of the protected system 100 to operate at its highest speed may be detrimental to a particular process operation and should not be allowed. If such a command is input from the input device 102, the autonomous control system 104 may intercept the signal and take immediate action to prevent the unauthorized state. In this example, the autonomous control system 104 may take control of the speed selection entirely and send an appropriate signal to the protected system 100 that maintains the previous authorized speed selection. In addition, the autonomous control system 104 may create a log entry or send an alert that an unauthorized connection state was attempted. The response of the autonomous control system 104 may be application dependent and may be pre-programmed. The autonomous control system 104 may also be programmed to stop the physical process instead of holding the current speed, for example.

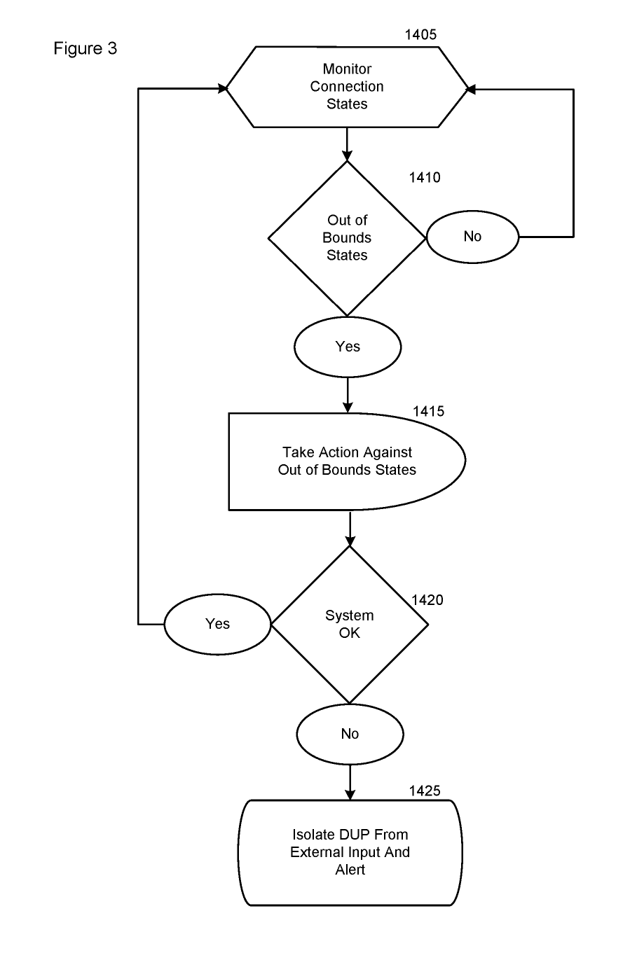

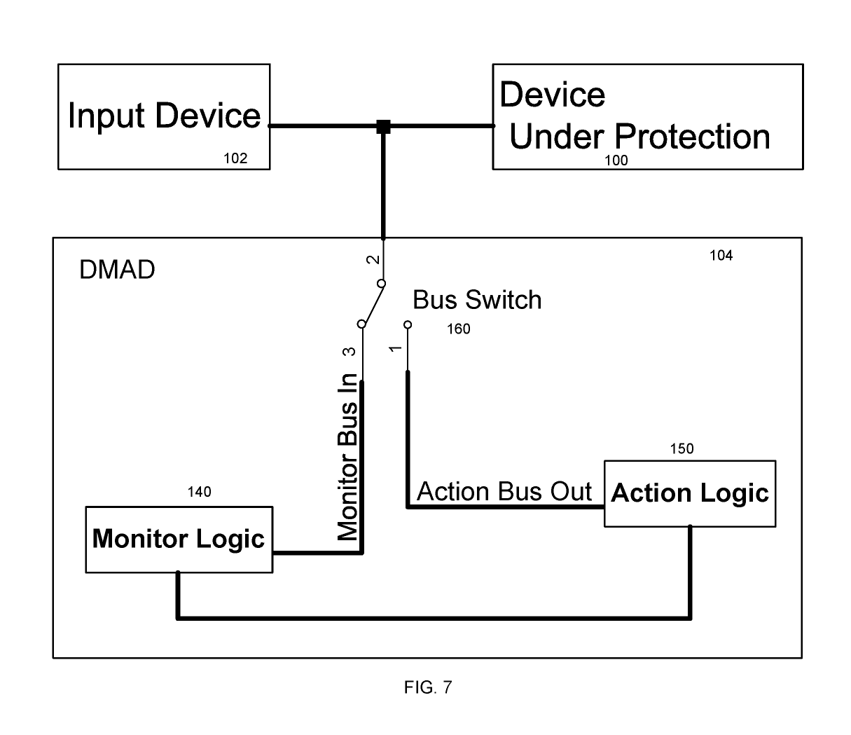

FIG. 3 is a flow diagram depicting a control method according to an embodiment of the invention. This diagram presents an example process flow for the serial autonomous control system 104 embodiment discussed above. The example process flow may also apply to additional serial and/or parallel autonomous control system 104 embodiments discussed below, which may or may not include the processor 200 and memory 202 of FIG. 2. The autonomous control system 104 may monitor connection states 1405 between the protected system 100 and input device 102. A state may be checked to determine whether it is out of bounds 1410 (e.g., a maximum speed command from the example of FIG. 2 above). If the state is allowed, monitoring may continue normally 1405. If the state is out of bounds, the autonomous control system 104 may take action against the state 1415 (e.g., by setting the speed to a lower speed than the commanded speed or by instructing the protected system 100 to maintain its current speed). The autonomous control system 104 may determine whether its intervention set or restored the protected system 100 to an acceptable state 1420. For example, the autonomous control system 104 may determine whether a motor has actually reverted to a lower speed with no damage done. If the protected system 100 is OK, monitoring may continue normally 1405. However, in some cases, it may be impossible to revert a protected system 100 to an acceptable state. For example, if the protected system 100 is a lock, and it receives an unlock command before the autonomous control system 104 can intervene (e.g., in a parallel arrangement such as that described with respect to FIG. 7 below), a door controlled by the lock may already be opened. Locking the lock again will not fix this condition. In this case, the protected system 100 may be isolated from further external input, and an alert may be generated 1425.

FIG. 4 is block diagram of an autonomous control system 104 connected with a serial interface between a protected system 100 and an input device 102, according to an embodiment of the invention. This embodiment may function similarly to that of FIG. 2 discussed above, but may have other elements in addition to and/or in place of the processor 200 and memory 202 within the autonomous control system 104. In this example, the autonomous control system 104 may include a PLD or other device (e.g., a circuit, a processor, etc.) providing monitoring logic 140. The monitoring logic 140 may normally pass all signals between the protected system 100 and a peripheral 102 through a bidirectional multiplexor (MUX) 160. The same signals may also be fed into a monitoring and action circuit providing control logic 150 which may be part of the PLD, circuit, or processor providing the monitoring logic 140 or may be separate from the monitoring logic 140 (e.g., a separate PLD, circuit, processor, etc.). The embodiment depicted in this figure is a hardware-based serial “man-in-the-middle” (MITM) implementation of the autonomous control system 104. In this embodiment, communication between the protected system 100 and peripherals 102 may continue normally until the monitoring logic 140 detects a pre-programmed prohibited signal pattern, packet, or access attempt on the signal lines. When the prohibited signal is detected, control logic 150 in the autonomous control system 104 may completely disable the primary peripheral I/O bus by selecting an alternate internal I/O bus (or disrupt bus) for recording, disrupting, or total disconnection from the peripheral 102. This method may be implemented in the autonomous control system 104 while communication is maintained with the protected system 100 to notify the protected system 100 that it is under attack. The autonomous control system 104 may maintain this communication by using an internal parameterized multiplexor instantiation whose channel select lines are controlled by the application-specific monitoring and action logic that is programmed into the protected system 100.

The autonomous control system 104 of FIG. 4 may be connected in series at the physical layer between a protected system 100 CPU and a connected peripheral 102 that can be internal or external to the protected system 100. The communication bus may pass through an autonomous control system 104 comprising the monitor logic 140 and MUX 160 that is programmed to detect signals that violate rules for a given application. When such signals are detected, autonomous control system 104 may stop them from reaching the protected system 100 or at least prevent them from asserting at the protected system 100 for a length of time that is undesirable for a process. In the example of FIG. 4, Bus A may normally pass through autonomous control system 104 between the protected system 100 CPU and the peripheral 102 and carry signals to and from the protected system 100 CPU. In doing so, Bus A may pass through the output multiplexor of autonomous control system 104. Whether Bus A or B reaches the protected system 100 may be determined by the “S0” control port of the multiplexor. When the S0 port is a logical 0, Bus A may pass through. When the S0 port is a logical 1, Bus B may pass through. The value of each line of Bus B may be controlled by autonomous control system 104's state machine control logic 150 that may be configured to enforce rules. In this example, S0 can assert to a logical 1 when all of the lines of Bus A are high. The 4-input AND gate may toggle S0 to switch to Bus B in response. The AND gate may be a hardware gate, and propagation times through hardware AND gates may be on the order of nanoseconds, so a near-instantaneous switch may be performed. S0 can also be controlled directly by autonomous control system 104's state machine logic 150 via the 2-input OR gate that feeds S0. Multiple instances of the autonomous control system 104 can be interposed between various inputs and/or outputs of the protected system 100 and input device 102 to enforce a variety of rules on a variety of interfaces.

Also shown in FIG. 4 is a secured memory which may store and encrypt data. The memory may be employed as a autonomous control system 104 system service to the host CPU and/or may contain data isolated from the host CPU such as a log of rule violation events which may be read out from a secure application or external peripheral.

The autonomous control system 104 depicted in the example of FIG. 4 may be arranged in a serial interface using a programmable logic device with the feature that the induced signal propagation delay through the autonomous control system 104 for the monitored lines is negligible for system timing requirements. The PLD in the autonomous control system 104 may include a normal “pass-through” mode that adds a small amount of propagation delay, for example a delay on the order of twenty nanoseconds. The added delay may be inconsequential for many systems and therefore may not affect normal system operation.

The serial interface of the autonomous control system 104 depicted in the example of FIG. 4 may be able to partially or completely disconnect the protected system 100 from a peripheral 102 to electrically isolate the protected system 100 as an anti-tamper measure. The autonomous control system 104 may then output any offensive, defensive, or diagnostic/repair signals to an attacking or malfunctioning peripheral 102, or simply hold state.

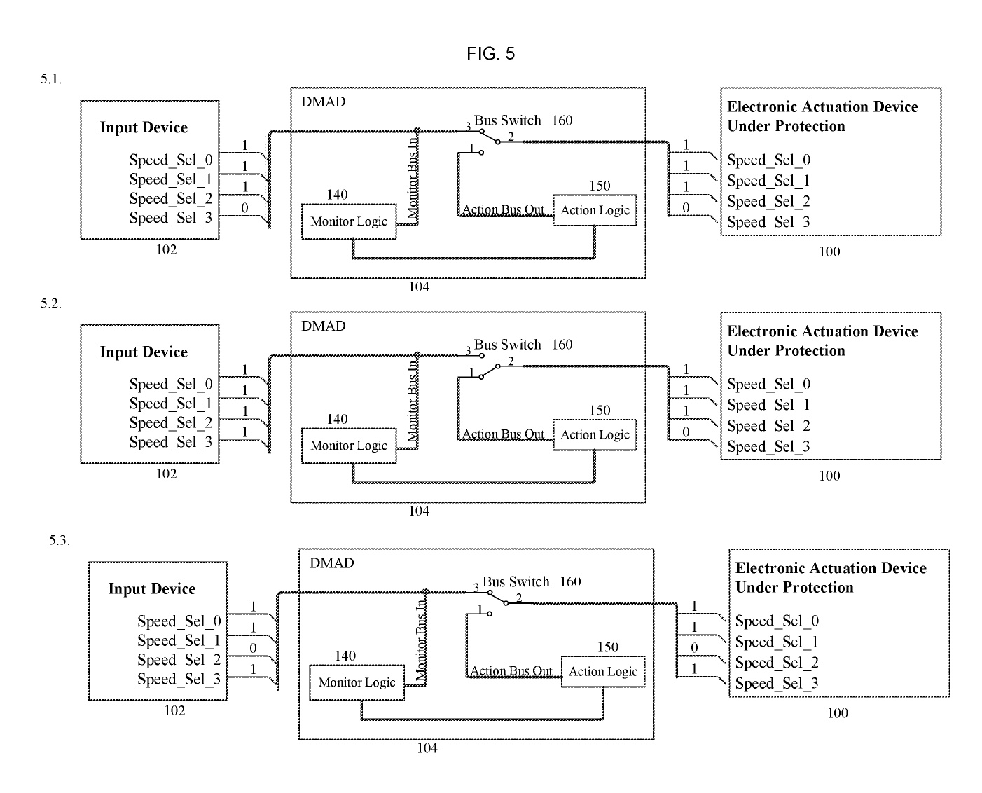

FIG. 5 is a schematic diagram depicting operation of an electronic autonomous control system 104 with a serial interface preventing an unauthorized connection state according to an embodiment of the invention. The autonomous control system 104 may be positioned between a speed selection input device (peripheral 102) and an actuation device (protected system 100) that accepts a binary encoded speed to apply to a physical process. The autonomous control system 104 may include monitoring logic 140 to monitor inputs and pass them to a multiplexer (MUX) or switch 160. If the inputs are allowed, they may proceed from the MUX 160 to the protected system 100. If the inputs are not allowed, the state machine monitor and control action logic 150 may intervene and cause the MUX 160 to pass an output generated by the state machine monitor and control action logic 150 to the protected system 100 instead. In this example, the highest speed, represented by binary “1111”, is detrimental to a particular process operation and should not be allowed. The device depicted in FIG. 5 can be scaled to monitor and act upon a large number of connection states that encode a wide variety of different functions. The autonomous control system 104 in this example may also be programmed to prevent unauthorized sequences of speed selections such as jumping immediately from the lowest to the highest allowed speed, for example. Autonomous control system 104 logic may be application specific, so while “1111” is a forbidden input in this example, other inputs may be forbidden in other embodiments. Inputs to the autonomous control system 104 are not limited to the 4-bit embodiment of this example.

In FIG. 5.1, a speed selection bus serially passes signals through the autonomous control system 104 and on to the actuation device via the autonomous control system 104's “bus switch”. The autonomous control system 104 may monitor the speed selection bus for programmable unauthorized speeds (connection states) and take a pre-programmed action, in this example controlling the bus switch. In FIG. 5.1 the selected speed is an authorized speed, therefore the autonomous control system 104 allows the selection to pass through to the actuation device.

FIG. 5.2 depicts an unauthorized signal for speed, “1111”, transmitted to the autonomous control system 104 through an input device 102 either inadvertently or maliciously. The autonomous control system 104 may intercept the signal and take immediate action to prevent the unauthorized state. In this example, the autonomous control system 104 may include pre-programmed action logic to toggle the bus switch such that the autonomous control system 104 takes control of the speed selection entirely and sends an appropriate signal to the protected system 100 that maintains the previous authorized speed selection. In addition, the autonomous control system 104 may create a log entry or send an alert that an unauthorized connection state was attempted. The response of the autonomous control system 104 may be application dependent and may be pre-programmed. The autonomous control system 104 may also be programmed to stop the physical process instead of holding the current speed, for example.

FIG. 5.3 illustrates that when the input device 102 is re-adjusted by a user or a control system to select an authorized speed, the autonomous control system 104 logic may switch control back to the input device 102 by toggling the bus switch back to a default steady-state position.

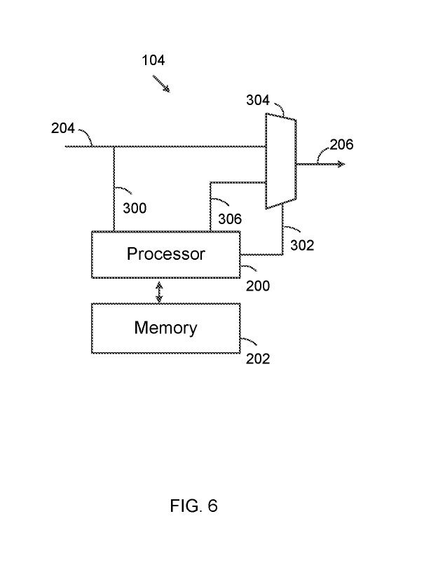

FIG. 6 illustrates an embodiment of the autonomous control system 104 similar to the embodiment of FIG. 5, but with a processor 200 and memory 202 in place of hardware logic. In this embodiment, input signals on node 204 may be routed to processor 200 via link 300. The processor 200 may compare input signals to prohibited input signal states stored in memory 202 and produce a match signal or a no match signal. The processor 200 may produce select signals on line 302, which may control MUX 304. Select signals may allow the signals on line 204 to pass through the multiplexer 304 to the protected system 100 in the event of a no match signal. Substitute input signals may be applied to line 306 and select signals on line 302 may pass the substitute input signals through the MUX 304 in the event of a match signal.

FIG. 7 is a block diagram of an autonomous control system 104, including a programmable logic device (PLD), connected with a parallel interface to a protected system 100, according to an embodiment of the invention. The inputs and/or outputs of the protected system 100 may be monitored via the inputs of the PLD in the autonomous control system 104 or via a processor embedded in the autonomous control system 104. In the embodiment shown in FIG. 5, the autonomous control system 104 may be connected with a parallel interface to the protected system 100 and may include at least one bidirectional signal driver that can monitor inputs, internally change state to outputs, and cause disruption with no extra connections needed. The driver may be coupled to monitoring logic 140 to monitor inputs received via switch 160 of the driver. If the inputs are allowed, the driver may maintain its state. If the inputs are not allowed, the action logic 150 may throw the switch 160 to an action bus out, which may be a ground or a high signal, for example. Communication between the protected system 100 and peripherals 102 may proceed normally until the monitoring logic detects an unauthorized signal pattern, packet, or access attempt, as in the serial interface example described above. In a parallel configuration, the control logic cannot internally re-route or disconnect the I/O bus by switching in an alternate I/O path for recording, disrupting, or total disconnection from the peripheral 102. Instead, the signal to the device under protection 100 is grounded or set high by the switch 160. However, the parallel approach may be useful for very high-speed systems with communication and signal speeds where propagation delays may not be tolerated (e.g., systems that operate in the GHz range). Furthermore, the parallel autonomous control system 104 may require fewer overall I/O connections than a serial interface because it does not have to pass signals through itself (requiring a matching output for every input).

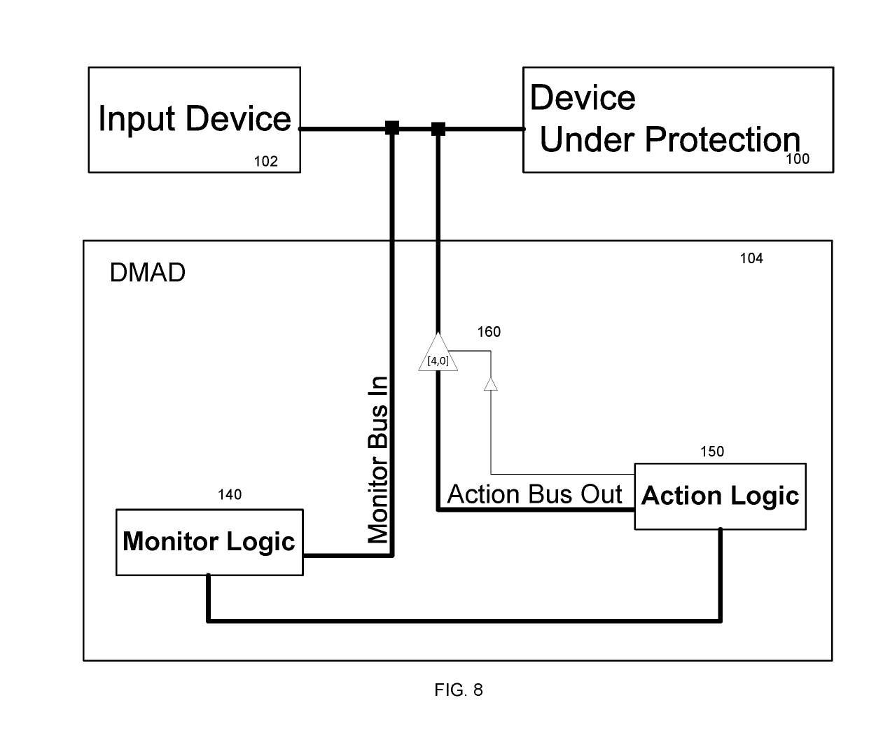

FIG. 8 is a block diagram of an embodiment of the autonomous control system 104 connected with a parallel interface to the protected system 100 and including at least one tri-state output 160 connected to the peripheral bus from the autonomous control system 104 (in place of the switch of FIG. 7) that may toggle to logic high or low when commanded in an effort to cause I/O disruption. This tri-state output may be used for autonomous control systems 104 that do not have bidirectional I/O interfaces.

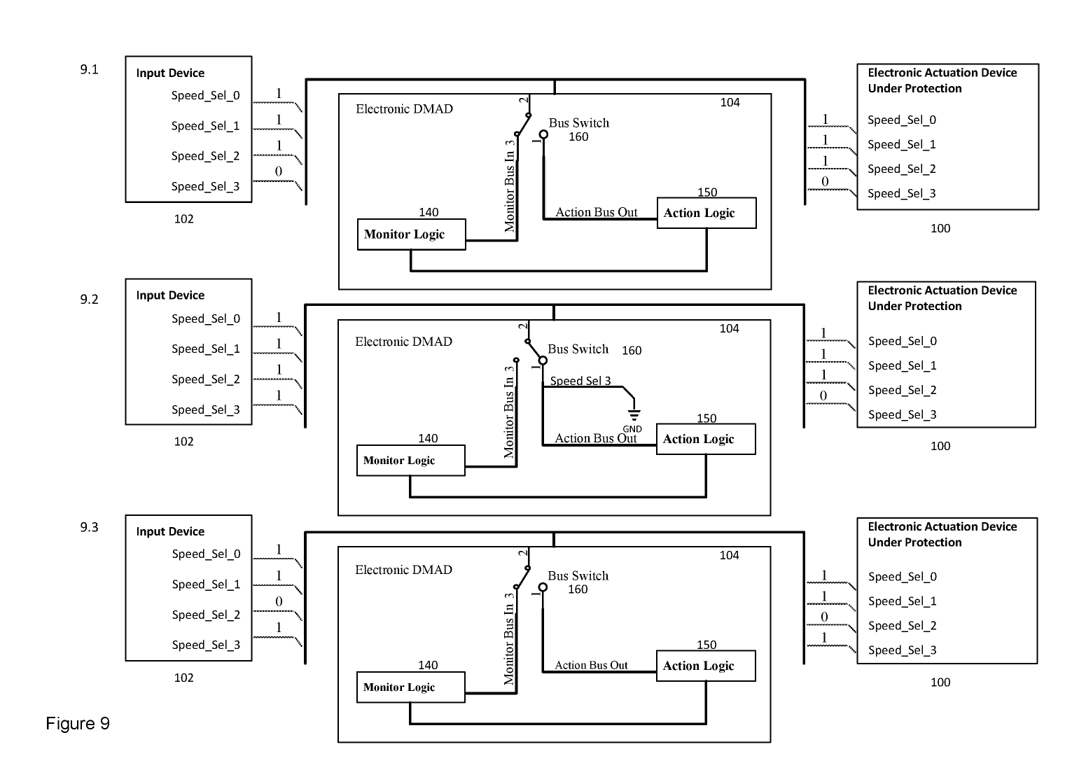

FIG. 9 is a schematic diagram depicting operation of an electronic autonomous control system 104 with a parallel interface according to an embodiment of the invention. The autonomous control system 104 may include a parallel interface where the signals between the input device 102 and protected device 100 do not pass directly through the autonomous control system 104. Instead, the autonomous control system 104 may tap off of each line with electrically high-impedance inputs to monitor the input signal as shown in FIG. 9.1. When an unauthorized input attempt is made, the parallel autonomous control system 104 may disrupt the unauthorized input by toggling the bus switch to an output bus having a drive-strength (current sinking and sourcing) suitable to override the host bus. In the example of FIG. 9.2, internally grounding the Speed_Sel_3 line may prevent it from reaching a logical high state that in turn selects the highest process speed. In FIG. 9.2, the autonomous control system 104 may periodically toggle the bus switch back to position 3 to monitor input from the input device 102 without interference from the autonomous control system 104 action bus output. When the autonomous control system 104 detects that an authorized speed is selected, it can move back to steady-state as shown in FIG. 9.3. The autonomous control system 104 with a parallel interface may not simultaneously monitor the signals, unlike the autonomous control system 104 with the serial interface.

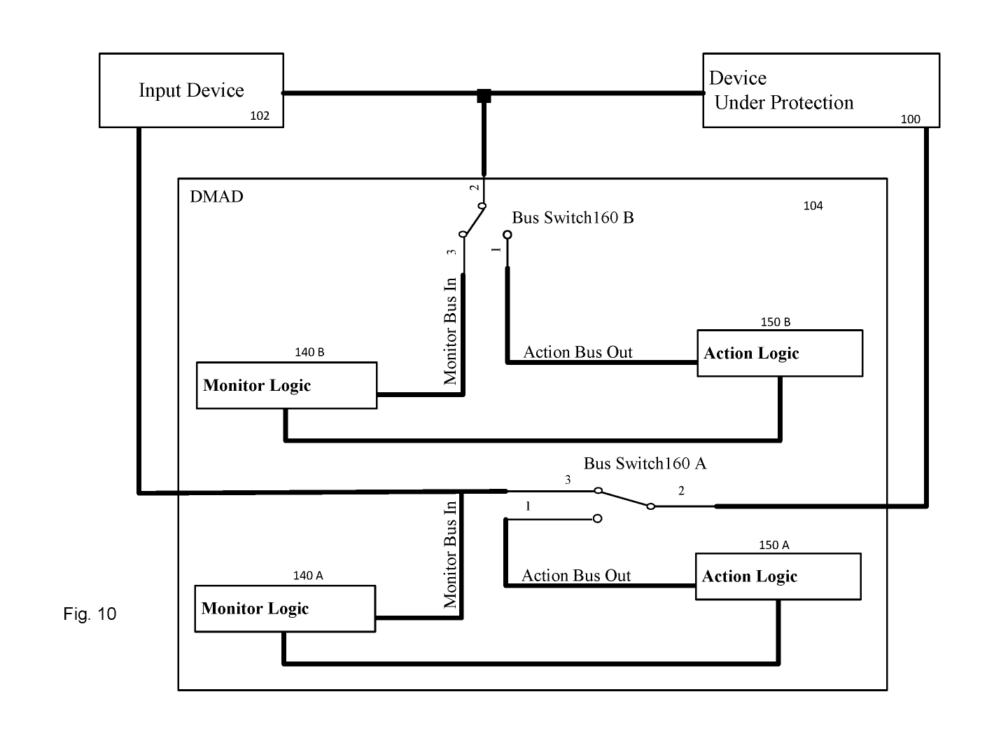

FIG. 10 is a block diagram of an embodiment in which the autonomous control system 104 is connected to the protected system 100 utilizing both a serial and a parallel interface. The serial interface includes monitor logic 140A, action logic 150A, and switch 160A. The parallel interface includes monitor logic 140B, action logic 150B, and switch 160B. In this embodiment, when certain communication paths are too fast to pass serially without degrading normal system operation, those paths may be handled by the parallel interface. Slower paths may be handled by the serial interface.

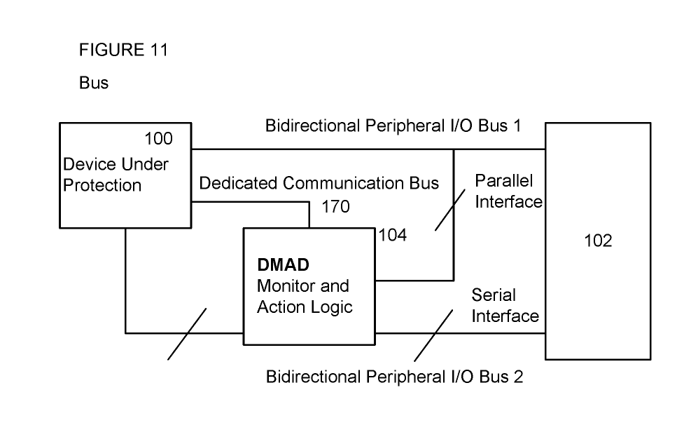

FIG. 11 is a block diagram of an embodiment in which the autonomous control system 104, regardless of interface, includes a communication bus 170 between the autonomous control system 104 and protected system 100. The communication bus 170 may enable a function of the autonomous control system 104 to optionally flag the protected system 100 if malicious or unauthorized intent is detected. The communication bus may also enable functions of the autonomous control system 104 for logging, alerting, or disabling at least one peripheral 102. Further, the communication bus 170 may allow the autonomous control system 104 to log events autonomously and report such events to a computer-implemented security scoring system.

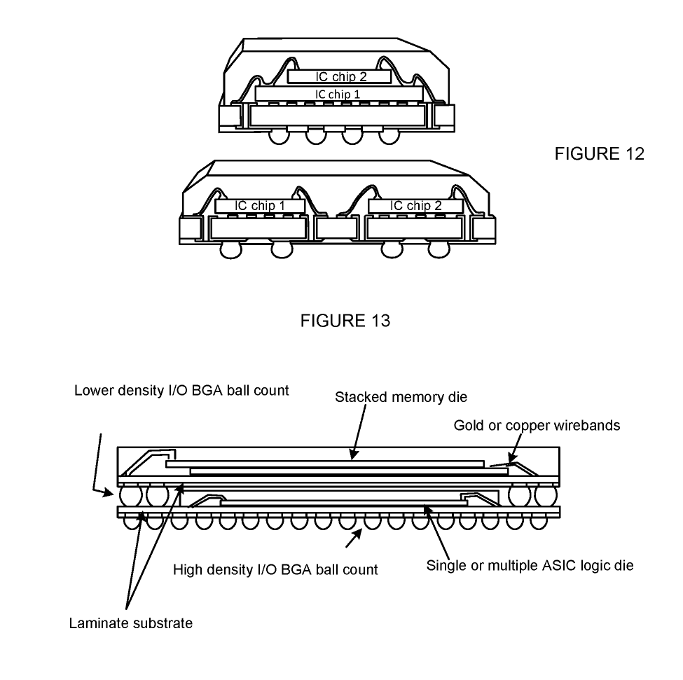

FIG. 12 is a diagram of an embodiment in which the autonomous control system 104 includes a semiconductor multi-chip module which may include at least two interconnected processor dies functionally connected in a stack or a planar array. The module may also include an interposer board and/or a direct wire bonding inside of a single semiconductor package that mounts directly to a printed circuit board (PCB). This arrangement may make it difficult to visually detect the autonomous control system 104, which may provide protection against malicious tampering.

FIG. 13 is a diagram of an embodiment in which the autonomous control system 104 is mounted externally on an interposer PCB, which may include a custom socket assembly that may be functionally arranged in a stack either above or below the protected system 100. In this embodiment, the autonomous control system 104 may be used to secure existing CPUs and use existing motherboards and sockets made for the CPUs. This implementation may be referred to as a package-on-package implementation because it involves connecting two individually packaged components to form one.

In some embodiments, the autonomous control system 104 may include an electronic circuit that may be surface mounted on a printed circuit board (PCB) that may include the protected system 100. The autonomous control system 104 may be operably connected to the protected system 100 using one or more PCB traces, flying leads, coaxial cables, or fiber optics, for example.

In some embodiments, the autonomous control system 104 may include a modular stackable single board-computing platform that may be operably mounted on the protected system 100. For example, the platform may be a PC104, EPIC, EBX, Raspberry Pi, Parallella, package on chip (POC), or a similar modular computing platform. In this embodiment, the autonomous control system 104 may include a modular carrier that may attach to a modular computing stack header and perform the securing functions described above. This may be referred to as a module-on-module implementation.

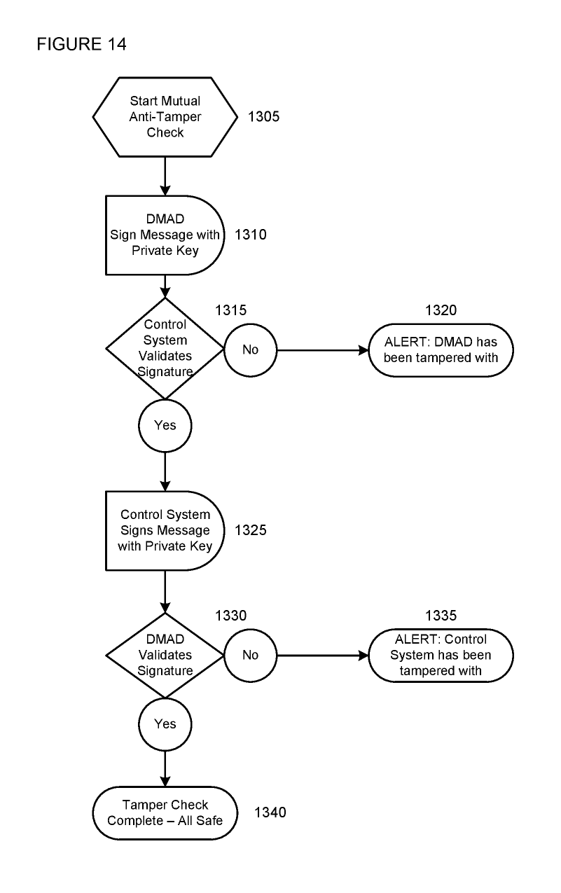

FIG. 14 is a flow diagram depicting anti-tamper features of the autonomous control system 104 according to an embodiment of the invention. As noted above, data may be stored to enable cryptographic anti-tamper checks of the autonomous control system 104. Periodically, or upon user request, an anti-tamper check may be initiated 1305. The autonomous control system 104 may sign a message to a system in communication with the autonomous control system 104 (i.e., the system performing the check of the autonomous control system 104) with a private key 1310. The system performing the check may attempt to validate the signature 1315. If the signature is invalid, an alert may be generated indicating that the autonomous control system 104 may have been tampered with 1320. If the signature is valid, the system performing the check may sign a message with a private key 1325. The autonomous control system 104 may attempt to validate the signature 1330. If the signature is invalid, an alert may be generated indicating that the system performing the check may have been tampered with 1335. If the signature is valid, the tamper check may be declared all safe (i.e., both the checking system and the autonomous control system 104 may be tamper free) 1340. Thus, the autonomous control system 104 may check another system and be checked by that system to provide mutual security.

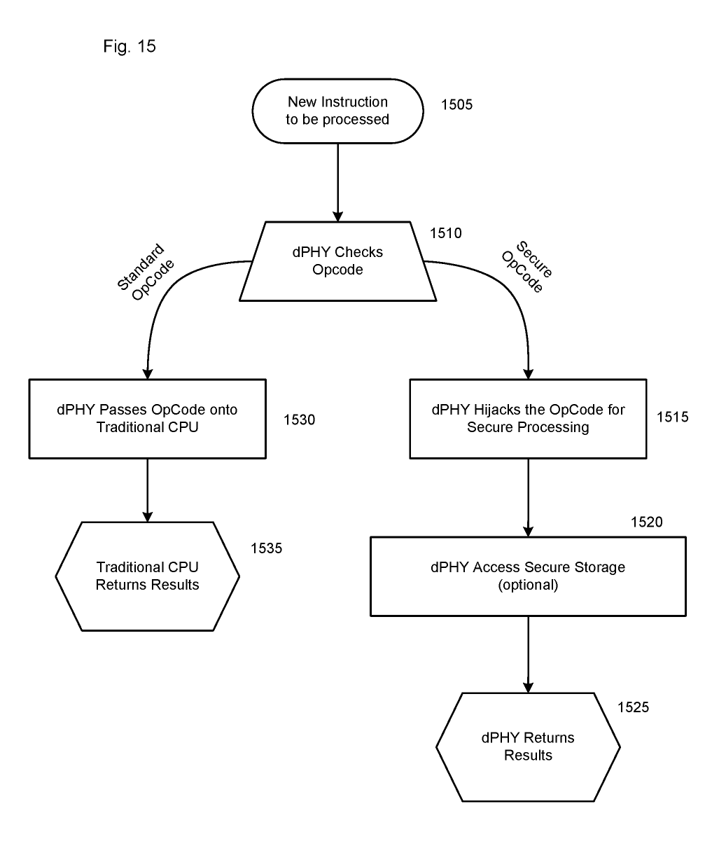

FIG. 15 shows a process flow of using the autonomous control system 104 as a system service to a host CPU for secure co-processing according to an embodiment of the invention. The architecture described above for the autonomous control system 104 may also enable secure processing as a system service to a host CPU since an autonomous control system 104 processor may have multiple instantiations of autonomous control systems. In this embodiment, the autonomous control system 104 may receive an instruction 1505. The autonomous control system 104 may compare the received instruction (e.g., from the input device 102) as reduced to machine language by a compiler, or opcode, 1510 to find a match to a pre-programmed opcode residing in a memory associated with the autonomous control system 104 memory sub-system. If there is a match, then the autonomous control system 104 may execute the opcode's pre-programmed function 1515, and the protected system 100 may not receive the opcode. The autonomous control system 104 may access secure storage 1520 and return results 1525. Alternately, if there is no match to the received opcode within autonomous control system 104 pre-programmed memory, then the opcode may be passed to the protected system 100 for execution 1530, and the protected system 100 may return results 1535. Software applications specifically designed to work with autonomous control system 104 executing on input device 102 may be required to contain autonomous control system 104 specific opcodes or instruction sets to access the secure co-processing capability of autonomous control system 104. For example, if such an autonomous control system 104 specific opcode or series of opcodes were to request a cryptographic signature on a data set, processor 200 may respond by first performing a cryptographic hash on the data set. Processor 200 may then digitally sign the hashed dataset using its private key (stored in secure storage 202), and then return the signed data set back to the autonomous control system 104 specific application that had generated the opcode in question via input device 102.

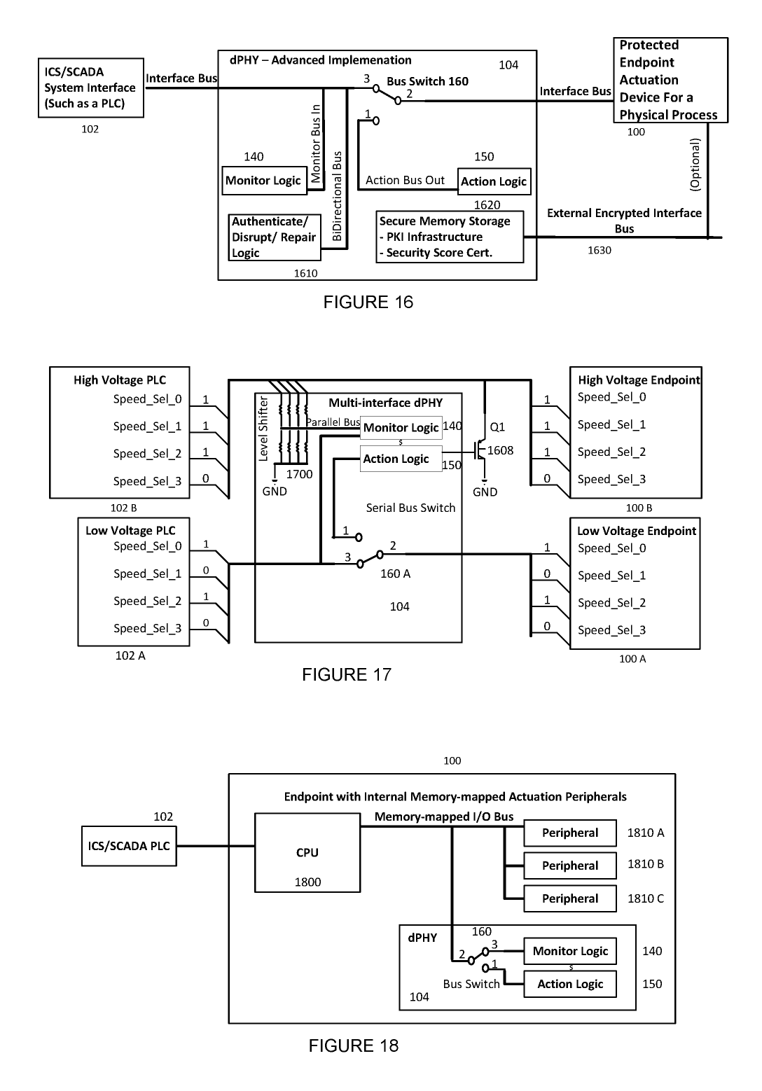

FIG. 16 is a serially interfaced autonomous control system with authenticate/disrupt/repair logic according to an embodiment of the invention. An autonomous control system 104 may be serially interfaced between an ICS/SCADA network 102 and a protected endpoint 100. The autonomous control system 104 may include authenticate/disrupt/repair logic 1610 and/or a secure memory 1620. The secure memory 1620 may hold electronic cryptographic PKI, private keys, digital authenticity, and/or security score certificates, for example. Such certificates may be used to digitally sign and encrypt messages with external devices and system components. For example, if an ICS/SCADA interface device 102 and/or protected endpoint 100 implement PKI, then the autonomous control system 104 may ensure authenticity before allowing the two devices to connect. An autonomous control system 104 with PKI may also perform encrypted communications with other devices that implement similar PKI.

A bidirectional bus interface may be provided from authenticate/disrupt/repair logic 1610 of the autonomous control system 104 to an ICS/SCADA device 102. This logic 1610 and bus can be used for the authentication measures described above and/or for further offensive or defensive measures when the monitor logic 140 detects unwanted connection states. For instance, the authenticate/disrupt/repair logic 1610 may emulate the protected endpoint 100 when an unwanted connection state is detected. The action logic 150 may assume control of the protected endpoint 100 during an unwanted connection state attempt (e.g., by holding a previous state or a new state appropriate for an application, as described above), and the authenticate/disrupt/repair logic 1610 may emulate the protected endpoint 100 by sending an expected response to the ICS/SCADA device 102 as if the protected endpoint 100 had changed state. A security/root-cause-analysis audit may be performed to log further commands to infer if the intent of the unwanted connection state attempt was erroneous or malicious. The security/root cause analysis may also be used to help restore the protected endpoint 100 to a known good state by sending a response or error message to the SCADA/ICS device 102 to notify it that is now communicating with an emulator due to a safety violation. The autonomous control system 104 may include an external encrypted interface bus 1630 connected to the protected endpoint 100. In some embodiments, the autonomous control system 104 may halt operation of the protected endpoint 100 via the interface bus 1630 while performing the security/root cause analysis. In other embodiments, the last authorized connection state (e.g., the state resulting from the last acceptable command) may be held during the security/root cause analysis.

FIG. 17 is a multi-interface autonomous control system according to an embodiment of the invention. An autonomous control system 104 may be connected to the protected endpoint 100 via both a serial and a parallel interface. As discussed above, this may be useful when certain communication paths are too fast to pass serially without degrading normal system operation. These fast communication paths may be given a parallel connection to normally high-impedance disruption outputs of an autonomous control system 104. A serial and parallel interface may also be used when signals have voltage levels that are too high for the autonomous control system 104. For example, an autonomous control system 104 in some embodiments may operate on signal of 5V or less. The autonomous control system 104 may be connected in series with a low voltage input device 102A and low voltage protected endpoint 100A, such that communications between the input device 102A and endpoint 100A may be allowed or disallowed with a low voltage switch 160A. The autonomous control system 104 may also be connected in parallel with a high voltage input device 102B and high voltage endpoint 100B, such that communications between the input device 102B and endpoint 100B may be allowed or disallowed with a high voltage switch 160B. The serial and parallel interfaces may function generally as described above with respect to other embodiments. However, to allow the autonomous control system 104 to monitor the signal on the parallel line, a level shifter 1700 (e.g., resistive ladders, opto-couplers, etc.) may be placed between the parallel line and the monitor logic 140. The level shifter 1700 may step down higher voltages so the autonomous control system 104 may safely monitor and act upon the parallel interface without damaging itself. When an unwanted connection state is detected, the autonomous control system 104 may short the entire high voltage bus by using a high power switch such as the insulated gate bipolar transistor (IGBT) 160B shown in FIG. 17. In some embodiments, the autonomous control system 104 with level shifter 1700 may be connected in parallel only, for example when the only signals available for monitoring in a system are high voltage signals.

FIG. 18 is an endpoint including a memory mapped peripheral according to an embodiment of the invention. An autonomous control system 104 may be interfaced as a memory mapped peripheral in an ICS/SCADA endpoint 100 that uses memory-mapped I/O, which may be a variety of parallel interface. An ICS/SCADA device 102 may communicate with a CPU 1800 of the endpoint 100. In this embodiment, the autonomous control system 104 may listen to bus communication and determine from the communication which peripherals 1810A, 1810B, 1810C are being accessed and what they are being instructed to do. When an unwanted connection state is detected, the autonomous control system 104 may act either by contending with the bus (i.e., overriding the signal as described above) or by interrupting the CPU 1800 and informing it of the bad state. An autonomous control system 104 in this embodiment may be used with memory-mapped schemes such as the IBM POWER8's Coherent Accelerator Processor Interface (CAPI) bus, where the autonomous control system 104 may autonomously monitor and directly control peripherals 1810A, 1810B, 1810C in the address space.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A system for autonomous enforcement of rules comprising:
a protected system at the physical signal interface of an Industrial Control Systems (ICS) and/or Supervisory Control and Data Acquisition (SCADA) network operative in response to input signals; and
an autonomous control system including a monitor circuit which is coupled to the input signals to monitor the input signals for violations of the rules and an action circuit coupled to the protected system which prevents the violating input signals from affecting the protected system.

2. The system of claim 1 wherein the input signals pass through the action circuit and are blocked by the action circuit from reaching the protected system when the monitoring circuit detects input signals which violate the rules.

3. The system of claim 1 wherein the autonomous control system is coupled to the input signals in parallel with the protected system.

4. The system of claim 1 wherein the monitor circuit and the action circuit include:
a memory for storing the rules; and
a processor which receives the input signals, applies the rules to the input signals and prevents input signals which violate the rules from affecting the protected system.

5. The system of claim 1 wherein the action circuit substitutes replacement signals for input signals in response to violating input signals.

6. The system of claim 5 wherein the replacement signals indicate to the protected system an attempt to apply violating input signals.

7. The system of claim 1 wherein the action circuit disables the protected circuit in response to violating input signals.

8. The system of claim 1 wherein the autonomous control system includes a memory and the autonomous control system stores violating input signals in the memory.

9. The system of claim 1 wherein the action circuit includes a multiplexor which receives the input signals and passes the input signals to the protected system in response to no violation of the rules being detected.

10. The system of claim 9 wherein the multiplexor provides replacement signals to the protected system in response to the input signals violating the rules.

11. The system of claim 1 wherein the action circuit is connected in series with the protected system with respect to at least a first one of the input signals and in parallel with the protected system with respect to at least a second one of the input signals.

12. The system of claim 1 further including a communication bus disposed between the protected system and the control system, the control system signaling the protected system in response to input signals which violate the rules over the communication bus.

13. The system of claim 1 wherein the control system is included in a common package with the protected system.

14. The system of claim 1 wherein the control system includes a control system private key disposed in the control system and the control system signs a message with the control system private key and sends the control system signed message to a source, the source determining whether the control system has been tampered with.

15. The system of claim 14 wherein the source includes a source private key disposed within the source and the source signs a message with the source private key and sends the source signed message to the control system, the control system determining whether the source has been tampered with.

16. The system of claim 1 wherein the monitor circuit is coupled to output signals of the protected circuit to monitor the output signals for violations of the rules and the action circuit prevents dissemination of the output signals in response to violating output signals.

17. The system of claim 1 wherein the control system enforces stronger access controls than those utilized by the protected system.

18. The system of claim 1 wherein the control system is connected to a physical layer of the protected system.

19. A method for protecting a protected system comprising:
monitoring input signals to the protected system with a monitor circuit of an autonomous control system, coupled to an Industrial Control Systems (ICS) and/or Supervisory Control and Data Acquisition (SCADA) network supplying the input signals, for input signals which violate rules; and
preventing violating input signals from affecting the protected system with an action circuit of the autonomous control system coupled to the protected system.

20. The method of claim 19 further comprising the action circuit blocking input signals to the protected system in response to the monitoring circuit detecting input signals which violate the rules.

21. The method of claim 19 further comprising coupling the autonomous control system to the input signals in parallel with the protected system.

22. The method of claim 19 further comprising:
storing the rules in a memory of the monitor circuit and the action circuit; and
a processor of the monitor circuit and the action circuit receiving the input signals, applying the rules to the input signals, and preventing input signals which violate the rules from affecting the protected system.

23. The method of claim 19 further comprising the action circuit substituting replacement signals for input signals in response to violating input signals.

24. The method of claim 23 wherein the replacement signals indicate to the protected system an attempt to apply violating input signals.

25. The method of claim 19 further comprising the action circuit disabling the protected circuit in response to violating input signals.

26. The method of claim 19 further comprising storing violating input signals in a memory of the autonomous control system.

27. The method of claim 19 further comprising receiving by a multiplexor of the action circuit the input signals and the multiplexor passing the input signals to the protected system in response to no violation of the rules being detected.

28. The method of claim 27 further comprising the multiplexor providing replacement signals to the protected system when the rules are violated.

29. The method of claim 19 further comprising connecting the action circuit in series with the protected circuit with respect to at least a first one of the input signals and in parallel with the protected system with respect to at least a second one of the input signals.

30. The method of claim 19 further comprising the control system signaling the protected system in response to input signals which violate rules over a communication bus disposed between the protected system and the control system.

31. The method of claim 19 further comprising packaging the control system and the protected system in a common package.

32. The method of claim 19 further comprising the control system signing a message with a control system private key disposed within the control system and sending the control system signed message to a source, the source determining whether the control system has been tampered with.

33. The method of claim 32 further comprising the source signing a message with a source private key disposed within the source and sending the source signed message to the control system, the control system determining from the source signed message whether the source has been tampered with.

34. The method of claim 19 further comprising:
monitoring output signals of the protected system with the monitor circuit for output signals that violate the rules; and
preventing dissemination of violating output signals from the protected system with the action circuit.

35. The method of claim 19 wherein the control system enforces stronger access controls than those utilized by the protected system.

36. The method of claim 19 further comprising connecting the control system to a physical layer of the protected system.

37. A system for autonomous enforcement of rules comprising:
a protected system operative in response to input signals; and
an autonomous control system including:
a monitor circuit which is coupled in series between a source of the input signals and the protected system to monitor the input signals for violations of the rules;
an action circuit coupled to the protected system which prevents the violating input signals from affecting the protected system; and
an authenticate/disrupt/repair logic circuit to send a message to the source of the input signals in response to a detection of violating input signals.

38. The system of claim 37, wherein the message emulates the protected system.

39. The system of claim 37, wherein the message includes an error message.

40. The system of claim 37 wherein the input signals pass through the action circuit and are blocked by the action circuit from reaching the protected system when the monitoring circuit detects input signals which violate the rules.

41. The system of claim 37 wherein the monitor circuit and the action circuit include:
a memory for storing the rules; and
a processor which receives the input signals, applies the rules to the input signals and prevents input signals which violate the rules from affecting the protected system.

42. The system of claim 37 wherein the action circuit substitutes replacement signals for input signals in response to violating input signals.

43. The system of claim 42 wherein the replacement signals indicate to the protected system an attempt to apply violating input signals.

44. The system of claim 37 wherein the action circuit disables the protected circuit in response to violating input signals.

45. The system of claim 37 wherein the autonomous control system includes a memory, and the autonomous control system stores violating input signals in the memory.

46. The system of claim 37, wherein:
the autonomous control system includes a memory;
the autonomous control system stores authentication data in the memory; and
the autonomous control system uses the authentication data to establish a connection between the source of the input signals and the protected system.

47. The system of claim 37 wherein the action circuit includes a multiplexor which receives the input signals and passes the input signals to the protected system in response to no violation of the rules being detected.

48. The system of claim 47 wherein the multiplexor provides replacement signals to the protected system in response to the input signals violating the rules.

49. The system of claim 37 wherein the action circuit is connected in series with the protected system with respect to at least a first one of the input signals and in parallel with the protected system with respect to at least a second one of the input signals.

50. The system of claim 37 further including a communication bus disposed between the protected system and the control system, the control system signaling the protected system in response to input signals which violate the rules over the communication bus.

51. The system of claim 37 wherein the control system is included in a common package with the protected system.

52. The system of claim 37 wherein the control system includes a control system private key disposed in the control system and the control system signs a message with the control system private key and sends the control system signed message to a source, the source determining whether the control system has been tampered with.

53. The system of claim 52 wherein the source includes a source private key disposed within the source and the source signs a message with the source private key and sends the source signed message to the control system, the control system determining whether the source has been tampered with.

54. The system of claim 37 wherein the monitor circuit is coupled to output signals of the protected circuit to monitor the output signals for violations of the rules and the action circuit prevents dissemination of the output signals in response to violating output signals.

55. The system of claim 37 wherein the control system enforces stronger access controls than those utilized by the protected system.

56. The system of claim 37 wherein the control system is connected to a physical layer of the protected system.

57. The system of claim 37, further comprising an interface bus between the control system and the protected system to send a message from the control system to the protected system.

58. A method for protecting a protected system comprising:
monitoring input signals to the protected system with a monitor circuit of an autonomous control system, coupled to the input signals in series between a source of the input signals and the protected system, for input signals which violate rules;
preventing violating input signals from affecting the protected system with an action circuit of the autonomous control system coupled to the protected system; and
sending a message to the source of the input signals in response to a detection of violating input signals with an authenticate/disrupt/repair logic circuit.

59. The system of claim 58, wherein the message emulates the protected system.

60. The system of claim 58, wherein the message includes an error message.

61. The method of claim 58 further comprising the action circuit blocking input signals to the protected system in response to the monitoring circuit detecting input signals which violate the rules.

62. The method of claim 58 further comprising:
storing the rules in a memory of the monitor circuit and the action circuit; and
a processor of the monitor circuit and the action circuit receiving the input signals, applying the rules to the input signals, and preventing input signals which violate the rules from affecting the protected system.

63. The method of claim 58 further comprising the action circuit substituting replacement signals for input signals in response to violating input signals.

64. The method of claim 63 wherein the replacement signals indicate to the protected system an attempt to apply violating input signals.

65. The method of claim 58 further comprising the action circuit disabling the protected circuit in response to violating input signals.

66. The method of claim 58 further comprising storing violating input signals in a memory of the autonomous control system.

67. The method of claim 58 further comprising:
storing authentication data in a memory of the autonomous control system; and
using the authentication data to establish a connection between the source of the input signals and the protected system.

68. The method of claim 58 further comprising receiving by a multiplexor of the action circuit the input signals and the multiplexor passing the input signals to the protected system in response to no violation of the rules being detected.

69. The method of claim 68 further comprising the multiplexor providing replacement signals to the protected system when the rules are violated.

70. The method of claim 58 further comprising connecting the action circuit in series with the protected circuit with respect to at least a first one of the input signals and in parallel with the protected system with respect to at least a second one of the input signals.

71. The method of claim 58 further comprising the control system signaling the protected system in response to input signals which violate rules over a communication bus disposed between the protected system and the control system.

72. The method of claim 58 further comprising packaging the control system and the protected system in a common package.

73. The method of claim 58 further comprising the control system signing a message with a control system private key disposed within the control system and sending the control system signed message to a source, the source determining whether the control system has been tampered with.

74. The method of claim 73 further comprising the source signing a message with a source private key disposed within the source and sending the source signed message to the control system, the control system determining from the source signed message whether the source has been tampered with.

75. The method of claim 58 further comprising:
monitoring output signals of the protected system with the monitor circuit for output signals that violate the rules; and
preventing dissemination of violating output signals from the protected system with the action circuit.

76. The method of claim 58 wherein the control system enforces stronger access controls than those utilized by the protected system.

77. The method of claim 58 further comprising connecting the control system to a physical layer of the protected system.

78. The method of claim 58, further comprising sending a message from the control system to the protected system via an interface bus between the control system and the protected system.

79. A system for autonomous enforcement of rules comprising:
a protected system operative in response to input signals;
an autonomous control system including a monitor circuit which is coupled to the input signals in parallel with the protected system to monitor the input signals for violations of the rules and an action circuit coupled to the protected system which prevents the violating input signals from affecting the protected system; and
a level shifter coupling the autonomous control system to the input signals and the protected system to shift the input signals from a first voltage useable by the protected system to a second voltage useable by the autonomous control system.

80. The system of claim 79 wherein the monitor circuit and the action circuit include:
a memory for storing the rules; and
a processor which receives the input signals, applies the rules to the input signals and prevents input signals which violate the rules from affecting the protected system.

81. The system of claim 79 wherein the action circuit substitutes replacement signals for input signals in response to violating input signals.

82. The system of claim 81 wherein the replacement signals indicate to the protected system an attempt to apply violating input signals.

83. The system of claim 79 wherein the autonomous control system includes a memory and the autonomous control system stores violating input signals in the memory.

84. The system of claim 79 wherein the action circuit is also connected in series with the protected system with respect to at least a first one of the input signals.

85. The system of claim 84 wherein the at least the first one of the input signals passes through the action circuit and is blocked by the action circuit from reaching the protected system when the monitoring circuit detects input signals which violate the rules.

86. The system of claim 84 wherein the action circuit disables the protected circuit in response to violating input signals.

87. The system of claim 84 wherein the action circuit includes a multiplexor which receives the at least the first one of the input signals and passes the at least the first one of the input signals to the protected system in response to no violation of the rules being detected.

88. The system of claim 87 wherein the multiplexor provides replacement signals to the protected system in response to the input signals violating the rules.

89. The system of claim 79 further including a communication bus disposed between the protected system and the control system, the control system signaling the protected system in response to input signals which violate the rules over the communication bus.

90. The system of claim 79 wherein the control system is included in a common package with the protected system.

91. The system of claim 79 wherein the control system includes a control system private key disposed in the control system and the control system signs a message with the control system private key and sends the control system signed message to a source, the source determining whether the control system has been tampered with.

92. The system of claim 91 wherein the source includes a source private key disposed within the source and the source signs a message with the source private key and sends the source signed message to the control system, the control system determining whether the source has been tampered with.

93. The system of claim 79 wherein the monitor circuit is coupled to output signals of the protected circuit to monitor the output signals for violations of the rules and the action circuit prevents dissemination of the output signals in response to violating output signals.

94. The system of claim 79 wherein the control system enforces stronger access controls than those utilized by the protected system.

95. The system of claim 79 wherein the control system is connected to a physical layer of the protected system.

96. A method for protecting a protected system comprising:
level shifting input signals from a first voltage useable by the protected system to a second voltage useable by an autonomous control system;
monitoring the level shifted input signals to the protected system with a monitor circuit of the autonomous control system, coupled to the input signals in parallel with the protected system via a level shifter, for input signals which violate rules; and
preventing violating input signals from affecting the protected system with an action circuit of the autonomous control system coupled to the protected system.

97. The method of claim 96 further comprising:
storing the rules in a memory of the monitor circuit and the action circuit; and
a processor of the monitor circuit and the action circuit receiving the input signals, applying the rules to the input signals, and preventing input signals which violate the rules from affecting the protected system.

98. The method of claim 96 further comprising the action circuit substituting replacement signals for input signals in response to violating input signals.

99. The method of claim 98 wherein the replacement signals indicate to the protected system an attempt to apply violating input signals.

100. The method of claim 96 further comprising storing violating input signals in a memory of the autonomous control system.

101. The method of claim 96 further comprising connecting the action circuit in series with the protected circuit with respect to at least a first one of the input signals.

102. The method of claim 101 further comprising the action circuit blocking the at least the first one of the input signals to the protected system in response to the monitoring circuit detecting input signals which violate the rules.

103. The method of claim 101 further comprising the action circuit disabling the protected circuit in response to violating input signals.

104. The method of claim 101 further comprising receiving by a multiplexor of the action circuit the at least the first one of the input signals and the multiplexor passing the at least the first one of the input signals to the protected system in response to no violation of the rules being detected.

105. The method of claim 104 further comprising the multiplexor providing replacement signals to the protected system when the rules are violated.

106. The method of claim 96 further comprising the control system signaling the protected system in response to input signals which violate rules over a communication bus disposed between the protected system and the control system.

107. The method of claim 96 further comprising packaging the control system and the protected system in a common package.

108. The method of claim 96 further comprising the control system signing a message with a control system private key disposed within the control system and sending the control system signed message to a source, the source determining whether the control system has been tampered with.

109. The method of claim 108 further comprising the source signing a message with a source private key disposed within the source and sending the source signed message to the control system, the control system determining from the source signed message whether the source has been tampered with.

110. The method of claim 96 further comprising:
monitoring output signals of the protected system with the monitor circuit for output signals that violate the rules; and
preventing dissemination of violating output signals from the protected system with the action circuit.

111. The method of claim 96 wherein the control system enforces stronger access controls than those utilized by the protected system.

112. The method of claim 96 further comprising connecting the control system to a physical layer of the protected system.

113. A system for autonomous enforcement of rules comprising:
a protected system operative in response to input signals, the protected system including an input/output (I/O) bus and a plurality of peripherals coupled to the I/O bus; and
an autonomous control system including a monitor circuit which is coupled to the I/O bus to monitor the input signals on the I/O bus for violations of the rules and to determine which of the plurality of peripherals is being addressed by the input signals and an action circuit coupled to the protected system which prevents the violating input signals from affecting the protected system.

114. The system of claim 113 wherein the autonomous control system is coupled to the input signals in parallel with the plurality of peripherals.

115. The system of claim 113 wherein the monitor circuit and the action circuit include:
a memory for storing the rules; and
a processor which receives the input signals, applies the rules to the input signals and prevents input signals which violate the rules from affecting the protected system.

116. The system of claim 113 wherein the action circuit substitutes replacement signals for input signals in response to violating input signals.

117. The system of claim 116 wherein the replacement signals indicate to the protected system an attempt to apply violating input signals.

118. The system of claim 116, wherein the replacement signals are chosen based on which one of the plurality of peripherals is being addressed by the violating input signals.

119. The system of claim 113 wherein the action circuit disables the protected circuit in response to violating input signals.

120. The system of claim 113 wherein the autonomous control system includes a memory and the autonomous control system stores violating input signals in the memory.

121. The system of claim 113 wherein the control system is included in a common package with the protected system.

122. The system of claim 113 wherein the control system includes a control system private key disposed in the control system and the control system signs a message with the control system private key and sends the control system signed message to a source, the source determining whether the control system has been tampered with.

123. The system of claim 122 wherein the source includes a source private key disposed within the source and the source signs a message with the source private key and sends the source signed message to the control system, the control system determining whether the source has been tampered with.

124. The system of claim 113 wherein the monitor circuit is coupled to output signals of the plurality of peripherals to monitor the output signals for violations of the rules and the action circuit prevents dissemination of the output signals in response to violating output signals.

125. The system of claim 113 wherein the control system enforces stronger access controls than those utilized by the protected system.

126. The system of claim 113 wherein the control system is connected to a physical layer of the protected system.

127. A method for protecting a protected system comprising:
monitoring input signals on an input/output (I/O) bus of the protected system with a monitor circuit of an autonomous control system, coupled to the I/O bus, for input signals which violate rules and to determine which of a plurality of peripherals coupled to the I/O bus is being addressed by the input signals; and
preventing violating input signals from affecting the protected system with an action circuit of the autonomous control system coupled to the protected system.

128. The method of claim 127 further comprising coupling the autonomous control system to the input signals in parallel with the plurality of peripherals.

129. The method of claim 127 further comprising:
storing the rules in a memory of the monitor circuit and the action circuit; and
a processor of the monitor circuit and the action circuit receiving the input signals, applying the rules to the input signals, and preventing input signals which violate the rules from affecting the protected system.

130. The method of claim 127 further comprising the action circuit substituting replacement signals for input signals in response to violating input signals.

131. The method of claim 130, wherein the replacement signals are chosen based on which one of the plurality of peripherals is being addressed by the violating input signals.

132. The method of claim 130 wherein the replacement signals indicate to the protected system an attempt to apply violating input signals.

133. The method of claim 127 further comprising the action circuit disabling the protected circuit in response to violating input signals.

134. The method of claim 127 further comprising storing violating input signals in a memory of the autonomous control system.

135. The method of claim 127 further comprising packaging the control system and the protected system in a common package.

136. The method of claim 127 further comprising the control system signing a message with a control system private key disposed within the control system and sending the control system signed message to a source, the source determining whether the control system has been tampered with.

137. The method of claim 136 further comprising the source signing a message with a source private key disposed within the source and sending the source signed message to the control system, the control system determining from the source signed message whether the source has been tampered with.

138. The method of claim 127 further comprising:
monitoring output signals of the plurality of peripherals with the monitor circuit for output signals that violate the rules; and
preventing dissemination of violating output signals from the protected system with the action circuit.

139. The method of claim 127 wherein the control system enforces stronger access controls than those utilized by the protected system.

140. The method of claim 127 further comprising connecting the control system to a physical layer of the protected system.
